(19) United States
(12) Patent Application Publication
(10) Pub. No.: US 2011/0054877 A1
(43) Pub. Date: Mar. 3, 2011

(54) ANALYSIS SUPPORT COMPUTER PRODUCT, ANALYSIS SUPPORT APPARATUS, AND ANALYSIS SYSTEM

(75) Inventors: Kanako Imai, Kawasaki (JP); Shigeo Ishikawa, Kawasaki (JP)

(73) Assignee: FUJITSU LIMITED, Kawasaki-shi (JP)

(21) Appl. No.: 12/846,074

(22) Filed: Jul. 29, 2010

(30) Foreign Application Priority Data
Aug. 25, 2009 (JP) 2009-194102

(51) Int. Cl. G06G 7/62; G06F 17/50

(52) U.S. Cl. 703/17

(57) ABSTRACT

A non-transitory, computer-readable recording medium stores therein an analysis support program that causes a computer to execute receiving disposal position information indicative of respective disposal positions for jigs in information indicative of disposal positions set on a surface of an object model modeling an object; creating, using the object model and a jig model modeling a jig, an analytic model by modeling a state where the jigs are disposed respectively at the disposal positions that are on the surface of the object and indicated by the disposal position information; obtaining an analysis result for each of the disposal positions by executing strength analysis of the object using the analytic model; producing, by correlating the disposal positions and the analysis results for the disposal positions based on the obtained analysis results, a chart that displays at each of the disposal positions, a correlated analysis result; and outputting the chart.

### CROSS REFERENCE TO RELATED APPLICATIONS

This application is based upon and claims the benefit of priority of the prior Japanese Patent Application No. 2009-194102, filed on Aug. 25, 2009, the entire contents of which are incorporated herein by reference.

### FIELD

The embodiments discussed herein are related to a computer product, an apparatus, and a system that support mechanical analysis.

### BACKGROUND

Generally, in a strength analysis simulation of an object such as an electronic device or an electronic component, multiple force-application positions are designated on the object and by applying force at the positions, portions of poor strength are analyzed. Here, the user creates an analytic model of the object, executes analysis, and evaluates the results for each of the force-application positions.

Conventionally, to expedite strength analysis simulations, for example, a simulation apparatus stores therein for each unit area, the amount of deformation of an entire contact area occurring when a unit pressure is applied to a unit area of the area that a material contacts. The simulation apparatus computes the amount of deformation of the entire contact face using the pressure distribution of the contact face obtained during molding and the stored amount of deformation of the entire contact face (see, e.g., Japanese Laid-Open Patent Publication No. 2003-236907).

To support interpretation of the analysis results by the user, for example, a simulation apparatus obtains strength analysis simulation results and determines whether the analysis results obtained for a predetermined portion represent a predetermined deformation state in the predetermined portion, based on a threshold value set for the predetermined portion of the object under analysis (see, e.g., Japanese Laid-Open Patent Publication No. 2007-109065).

However, with the conventional technologies above, an analytic model necessary for the strength analysis simulation is manually generated for each of the force-application points and therefore, a problem arises in that the number of production steps increases. If an error (for example, an error in setting materials, constraint conditions, etc.) is found after the analysis, correction has to be executed independently for each of the analytic models, making correction work troublesome.

With the conventional technologies, the analysis result for each of the force-application positions is only converted into numerical values that are output and therefore, a problem arises in that it is difficult to intuitively determine weak points of the object. As a result, the user has to execute burdensome work such as separately preparing a diagram of the force-application positions, obtaining thereby an analysis result for each of the force-application positions, comparing the analysis results for the different force-application positions, and determining thereby the weak points. Therefore, a problem arises in that the time consumed for the evaluation of the results as well as the work load thereof increases.

### SUMMARY

According to an aspect of an embodiment, a non-transitory, computer-readable recording medium stores therein an analysis support program that causes a computer to execute a process that includes receiving input of disposal position information that indicates respective disposal positions for jigs in information that indicates disposal positions set on a surface of an object model modeling an object; creating, using the object model and a jig model modeling a jig, an analytic model by modeling a state where the jigs are disposed respectively at the disposal positions that are on the surface of the object and indicated by the disposal position information received at the receiving; obtaining an analysis result for each of the disposal positions by executing strength analysis of the object using the analytic model that is for each of the disposal positions and created at the creating; producing, by correlating the disposal positions and the analysis results based on the analysis result for each of the disposal positions obtained at the obtaining, a chart that displays at each of the disposal positions on the surface of the object, a correlated analysis result; and outputting the chart produced at the producing.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram of an exemplary overview of the analysis support approach.

FIG. 2 is a block diagram of a hardware configuration of an analysis support apparatus according to an embodiment.

FIG. 3 is a diagram of an exemplary object model.

FIG. 4 is a diagram of an exemplary object model file.

FIG. 5 is a diagram of an example of the content stored in an object model node table.

FIG. 6 is a diagram of an example of the content stored in a jig library.

FIG. 7 is a block diagram of a functional configuration of the analysis support apparatus.

FIG. 8 is a diagram of an example of selection of an area-under-analysis.

FIG. 9 is a diagram of an example of the content stored in the area-under-analysis node table.

FIG. 10 is a diagram of an example of setting disposal positions.

FIG. 11 is a diagram of an example of the content stored in a force-application position table.

FIG. 12 is a diagram of an example of a selection screen for disposal positions.

FIG. 13 is another diagram of the example of the content stored in the force-application position table.

FIG. 14 is a diagram of an example of an analytic model file.

FIG. 15 is a diagram of an example of an analysis result file.

FIG. 16 is a block diagram of an example of the functional configuration of the producing unit.

FIG. 17 is a diagram of an example of a designation screen for evaluation items.

FIG. 18 is a diagram of an example of the content stored in an evaluation item table.

FIG. 19 is a diagram of an example of the content stored in an analytic value table.

FIG. 20 is a diagram of an example of the content stored in a display height table.

FIGS. 22 and 23 are diagrams of exemplary screens.

FIG. 24 is a flowchart of an example of an analysis support process procedure of the analysis support apparatus.

FIG. 25 is a flowchart of an example of a process procedure of a disposal position setting process.

FIG. 26 is a flowchart of an example of a process procedure of a model creating process.

FIG. 27 is a flowchart of an example of a process procedure of a chart creating process.

### DESCRIPTION OF EMBODIMENTS

Preferred embodiments of the present invention will be explained with reference to the accompanying drawings.

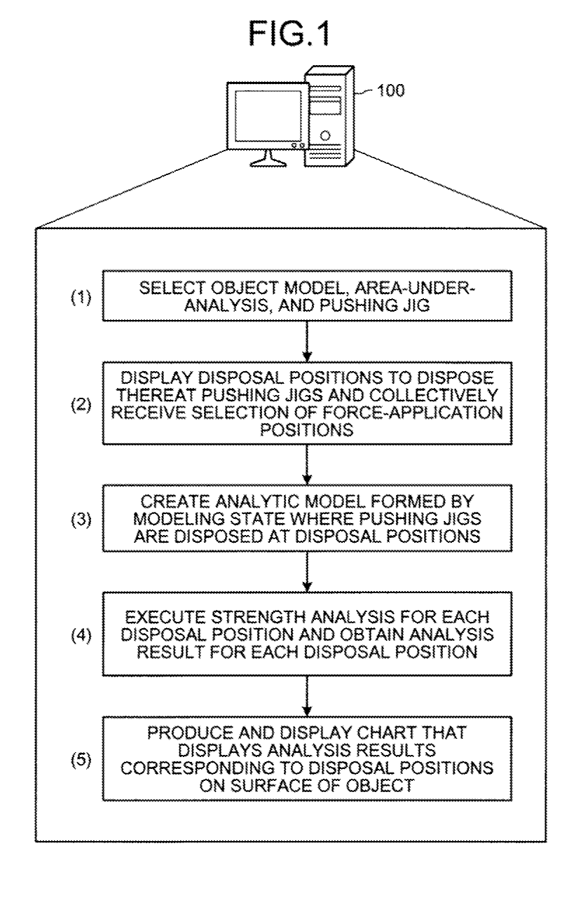

FIG. 1 is a diagram of an exemplary overview of the analysis support approach. Procedures (1) to (5) of the exemplary overview of the analysis support approach will be described.

(1) An analysis support apparatus 100 receives selection of an object model, an area-under-analysis, and a pushing jig. In this case, the object model is a model created by modeling an object under analysis. The area-under-analysis is an area of the surface of the object model and to which a pushing force is applied during analysis. The pushing jig is a jig to apply the pushing force to the area-under-analysis for the analysis.

(2) The analysis support apparatus 100 automatically sets on the area-under-analysis, disposal positions where pushing jigs are disposed, graphically displays the disposal positions, and collectively receives selection of the force-application positions. The disposal positions are equivalent to the force-application positions where a pushing force is applied to the surface of the object.

(3) Using the object model and a jig model, the analysis support apparatus 100 automatically creates an analytic model by modeling a state where a pushing jig is disposed at each of the disposal positions selected within the area-under-analysis. The jig model is a model of the pushing jig.

(4) The analysis support apparatus 100 executes strength analysis of the object using the analytic model created for each of the disposal positions and thereby, obtains an analysis result for each of the disposal positions. Herein, the strength analysis includes analysis of displacement, stress, strain, reaction force, etc., at each of the force-application positions by an application of a pushing force to the surface of the object.

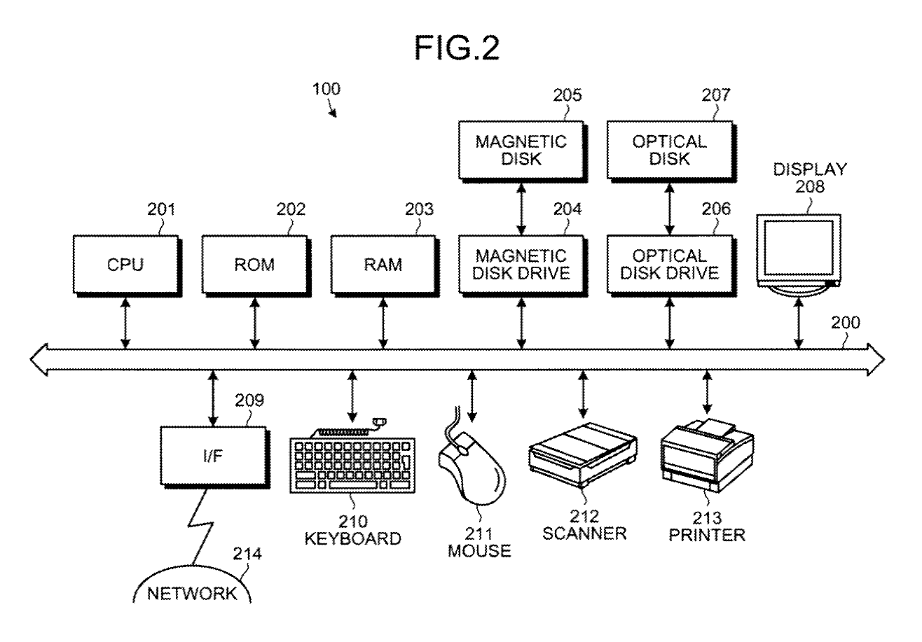

(5) The analysis support apparatus 100 correlates the disposal positions selected and the analysis results for the disposed positions, thereby generating and displaying on a display 208 (see FIG. 2) a table (see FIGS. 21 to 23) displaying the analysis results corresponding to the disposal positions on the surface of the object.

As described, according to the analysis support approach, when strength analysis is executed multiple times, changing the force-application position on the object, the force-application positions are collectively designated and an analytic model for each force-application position is created automatically. Thereby, the work load and the time consumed to manually produce the analytic model for each force-application position may be reduced.

According to the analysis support approach, the strength analysis is executed using an analytic model for each force-application position and the analysis results are collectively displayed at the corresponding force-application positions on the object. Thereby, the analysis results may be displayed collectively, correlated respectively with the force-application positions on the object to support the user in evaluating the strength.

FIG. 2 is a block diagram of a hardware configuration of an analysis support apparatus according to the embodiment. As depicted in FIG. 2, the analysis support apparatus includes a central processing unit (CPU) 201, a read-only memory (ROM) 202, a random access memory (RAM) 203, a magnetic disk drive 204, a magnetic disk 205, an optical disk drive 206, an optical disk 207, a display 208, an interface (I/F) 209, a keyboard 210, a mouse 211, a scanner 212, and a printer 213, respectively connected by a bus 200.

The CPU 201 governs overall control of the analysis support apparatus. The ROM 202 stores therein programs such as a boot program. The RAM 203 is used as a work area of the CPU 201. The magnetic disk drive 204, under the control of the CPU 201, controls the reading and writing of data with respect to the magnetic disk 205. The magnetic disk 205 stores therein data written under control of the magnetic disk drive 204.

The optical disk drive 206, under the control of the CPU 201, controls the reading and writing of data with respect to the optical disk 207. The optical disk 207 stores therein data written under control of the optical disk drive 206, the data being read by a computer.

The display 208 displays, for example, data such as text, images, functional information, etc., in addition to a cursor, icons, and/or tool boxes. A cathode ray tube (CRT), a thin-film-transistor (TFT) liquid crystal display, a plasma display, etc., may be employed as the display 208.

The I/F 209 is connected to a network 214 such as a local area network (LAN), a wide area network (WAN), and the Internet through a communication line and is connected to other apparatuses through the network 214. The I/F 209 administers an internal interface with the network 214 and controls the input/output of data from/to external apparatuses. For example, a modem or a LAN adaptor may be employed as the I/F 209.

The keyboard 210 includes, for example, keys for inputting letters, numerals, and various instructions and performs the input of data. Alternatively, a touch-panel-type input pad or numeric keypad, etc. may be adopted. The mouse 211 is used to move the cursor, select a region, or move and change the size of windows. A track ball or a joy stick may be adopted provided each respectively has a function similar to a pointing device.

The scanner 212 optically reads an image and takes in the image data into the analysis support apparatus. The scanner 212 may have an optical character recognition (OCR) function as well. The printer 213 prints image data and text data. The printer 213 may be, for example, a laser printer or an ink jet printer.

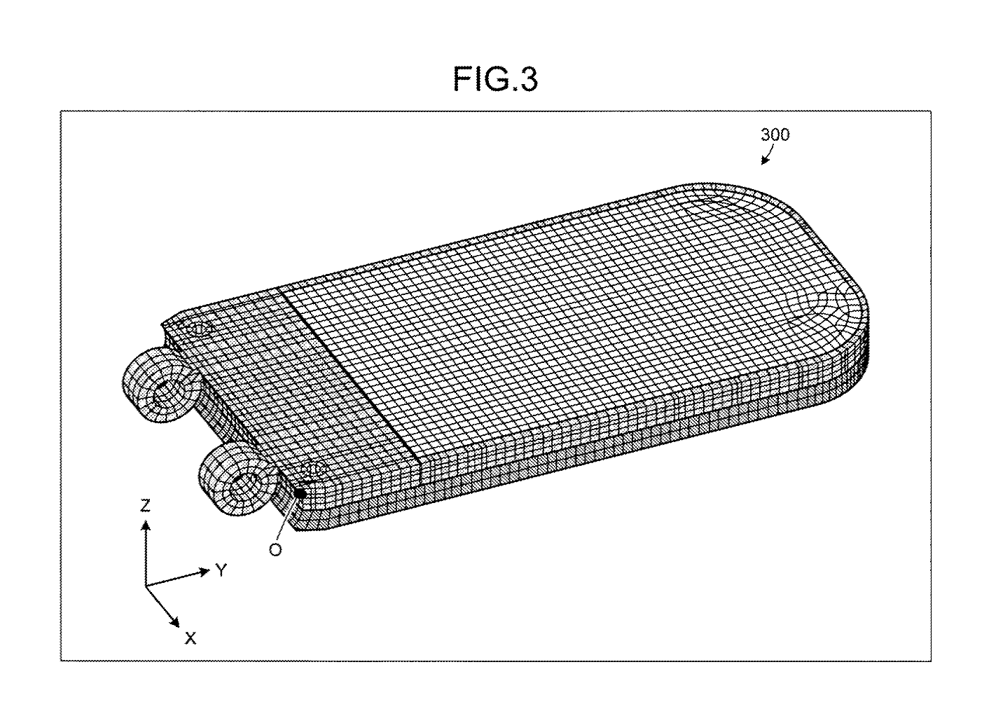

FIG. 3 is a diagram of an exemplary object model. In FIG. 3, an object model 300 is displayed in a Cartesian coordinate system configured by an X-axis, a Y-axis, and a Z-axis that respectively cross at right angles. In FIG. 3, a point “O” is the origin.

The object model 300 is created by modeling a display unit that, among components of a folding-type cellular telephone terminal, includes a liquid crystal display (LCD). The object model 300 is represented as a set of elements. The elements divide the object model 300 into hexahedrons and pentahedrons and each element has multiple nodes. A node is a point that characterizes the shape of an element (for example, vertices of an element).

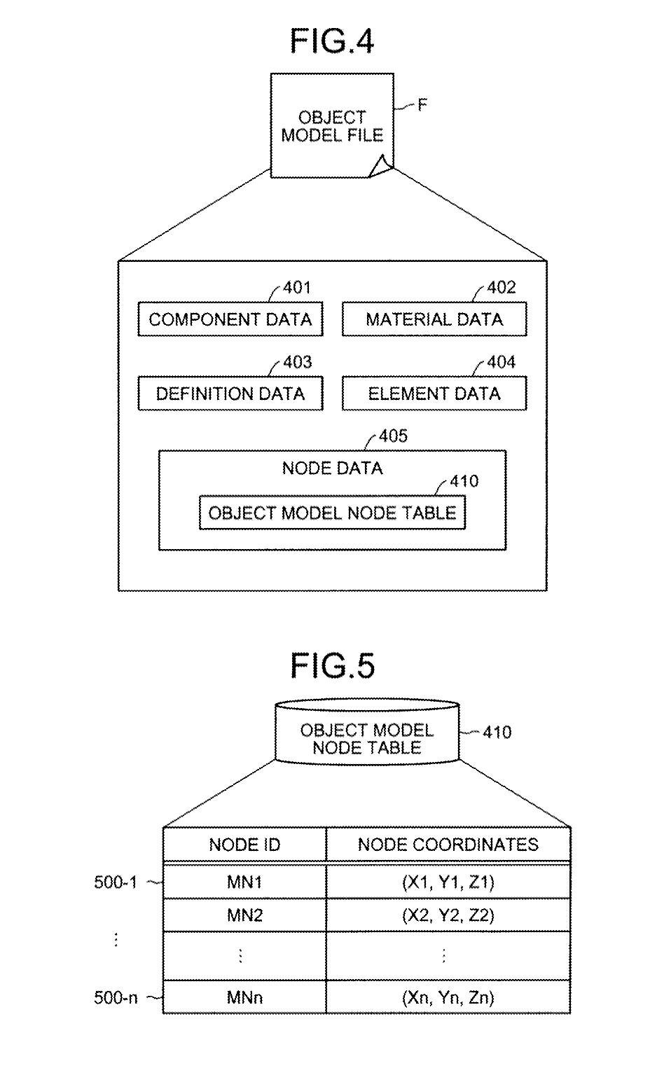

FIG. 4 is a diagram of an example of an object model file. In FIG. 4, an object model file F includes component data 401, material data 402, definition data 403, element data 404, and node data 405.

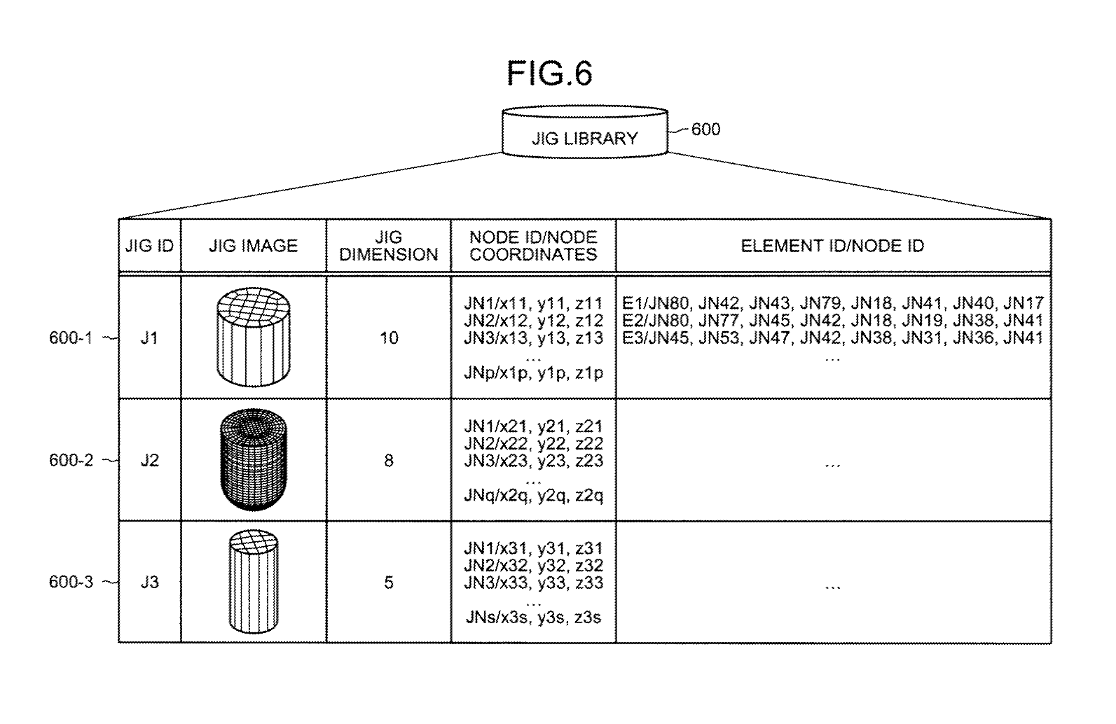

The component data 401 is information concerning components that configure the object. The material data 402 is information concerning materials of the components. The definition data 403 is information that defines various conditions for executing the analysis such as constraint conditions and load conditions. The element data 404 is information concerning the elements included in the object model 300 and includes, for example, information to identify the nodes included in the elements. The node data 405 is information concerning the nodes included in the object model 300 and includes, for example, an object model node table 410 (see FIG. 5).

FIG. 5 is a diagram of an example of the content stored in the object model node table. In FIG. 5, the object model node table 410 has fields including “node ID” and “node coordinates”. Node information items 500-1 to 500-n are stored as records by setting information in each of the fields.

Herein, a “node ID” is an identifier of a node that is included in the object model 300 and “node coordinates” are coordinates of a node in the object model 300. For example, with respect to node information item 500-1, the node coordinates of a node MN1 are (X1, Y1, Z1). The node coordinates of each node are relative to the point O depicted in FIG. 3 as the origin.

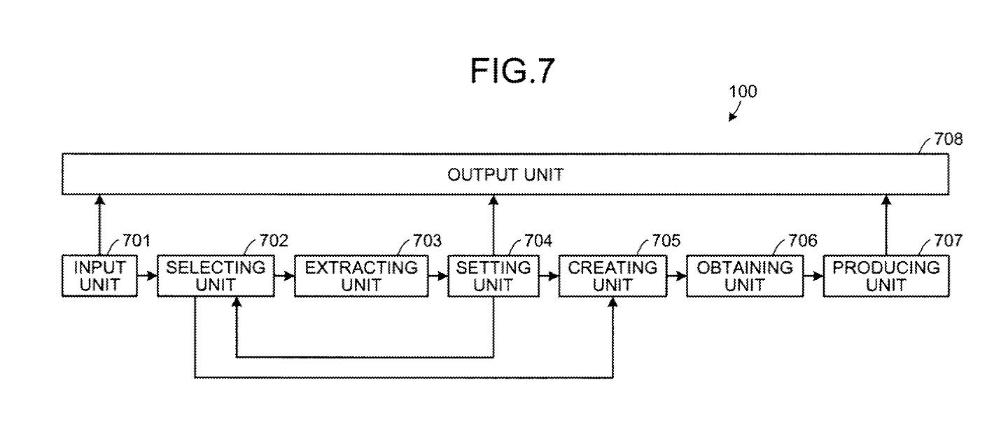

FIG. 6 is a diagram of an example of the content stored in a jig library. In FIG. 6, a jig library 600 includes fields of “jig ID”, “jig image”, “jig dimension”, “node ID/node coordinates”, and “element ID/IDs of nodes constituting the element”. Jig information items 600-1 to 600-3 are stored as records by setting information in each of the fields.

Herein, a “jig ID” is an identifier of a pushing jig; a “jig image” is an image representing a pushing jig; “jig dimension” is the diameter (in, for example, millimeters) of a pushing face of a pushing jig; and each “node ID/node coordinates” indicates an identifier of a node included in an element formed by partitioning a pushing jig into a mesh and the node coordinates of the node. The node coordinates are coordinates obtained when the center of the pushing face of a pushing jig is assumed as the origin. Each “element ID/node ID” indicates an identifier of an element and an identifier of a node that constitutes the element.

For example, with respect to the jig information item 600-1, the jig dimension of a pushing jig J1 is 10 [mm]. The node coordinates of a node JN1 included in the pushing jig J1 are, for example, (x11, y11, z11). Nodes constituting an element E1 that is included in the pushing jig J1 are eight that are nodes JN80, JN42, JN43, JN79, JN18, JN41, JN40, and JN17.

Although it is assumed that the pushing face of the pushing jig is circular in the example above, the shape of the pushing face is not limited to hereto. The pushing face may be, for example, square or rectangular and, in such a case, “jig dimension” includes longitudinal and lateral dimensions of a pushing face. The jig library 600 is stored in a storage device such as, for example, the ROM 202, the RAM 203, the magnetic disk 205, and the optical disk 207 depicted in FIG. 2.

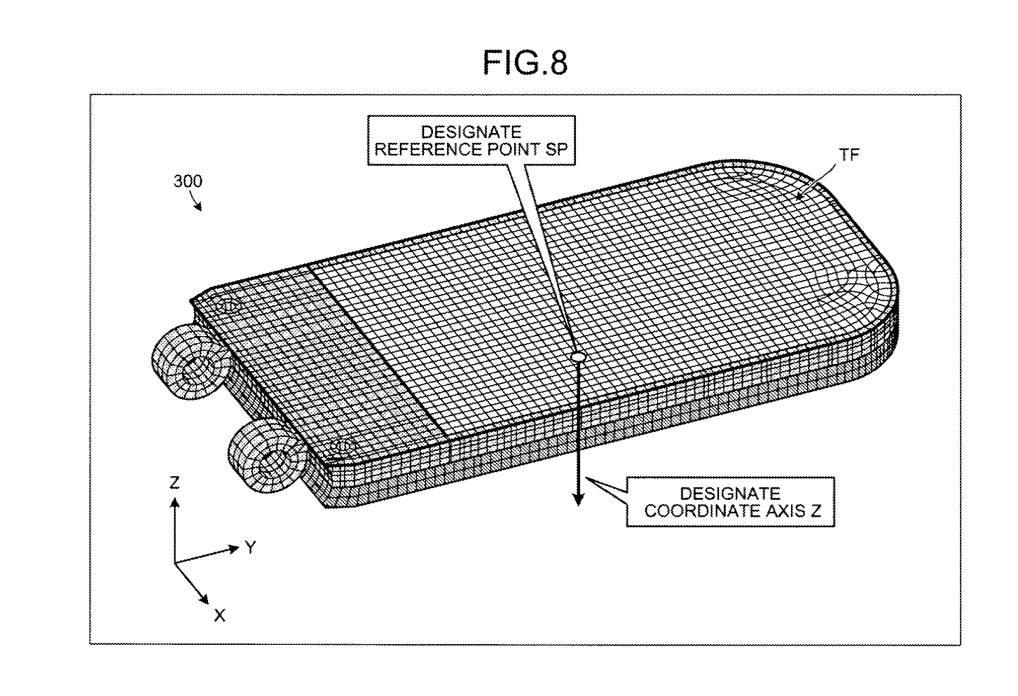

FIG. 7 is a block diagram of a functional configuration of the analysis support apparatus. As depicted in FIG. 7, the analysis support apparatus 100 includes an input unit 701, a selecting unit 702, an extracting unit 703, a setting unit 704, a creating unit 705, an obtaining unit 706, a producing unit 707, and an output unit 708. These functions (the input unit 701 to the output unit 708) that constitute a control unit are implemented by causing the CPU 201 to execute a program that is stored in the storage device such as, for example, the ROM 202, the RAM 203, the magnetic disk 205, and the optical disk 207 depicted in FIG. 2, or by the I/F 209.

The input unit 701 has a function of receiving input of the object model file F. Herein, the object model file F is electronic data concerning the object model created by modeling the object. For example, user input via the keyboard 210 or the mouse 211 depicted in FIG. 2 causes the input unit 701 to receive the input of the object model file F (see FIG. 4) concerning the object model 300 depicted in FIG. 3.

If the object model file F to be input concerns multiple object models, the user selects an arbitrary object model from among the object models. The object model file F input is stored in a storage area such as the RAM 203, the magnetic disk 205, and the optical disk 207.

The input unit 701 receives input of disposal position information that indicates disposal positions of jigs. Herein, the disposal position information indicates the disposal positions of the jigs included in information that indicates disposal positions set on the surface of the object model that is created by modeling the object. For example, the disposal position information is information that corresponds to a selection result obtained by the selecting unit 702 described hereinafter and is information that corresponds to a disposal position group set by the setting unit 704 described hereinafter.

The disposal position information may include information identifying a face of the surface of the object model to which a pushing force is to be applied and a pushing jig to do so. The disposal position information input is stored to the storage area such as the RAM 203, the magnetic disk 205, and the optical disk 207.

The selecting unit 702 has a function of selecting an area (hereinafter, “area-under-analysis TF”) of the surface of the object model to which a pushing force is to be applied. For example, user input via the keyboard 210 or the mouse 211 may cause the selecting unit 702 to receive designation of the area-under-analysis TF. The selecting unit 702 may also select the area-under-analysis TF by referring to the disposal position information input. The area-under-analysis TF selected is stored to the storage area such as the RAM 203, the magnetic disk 205, and the optical disk 207.

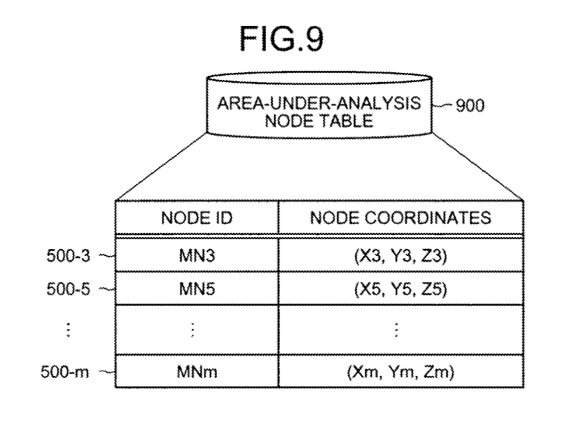

FIG. 8 is a diagram of an example of selection of an area-under-analysis. As depicted in FIG. 8, a surface of the LCD display unit is selected from the surface of the object 300, as the area-under-analysis TF. In this example, the user designates a reference point SP and the Z-axis that is the direction of the pushing force and thereby, the area-under-analysis TF is selected.

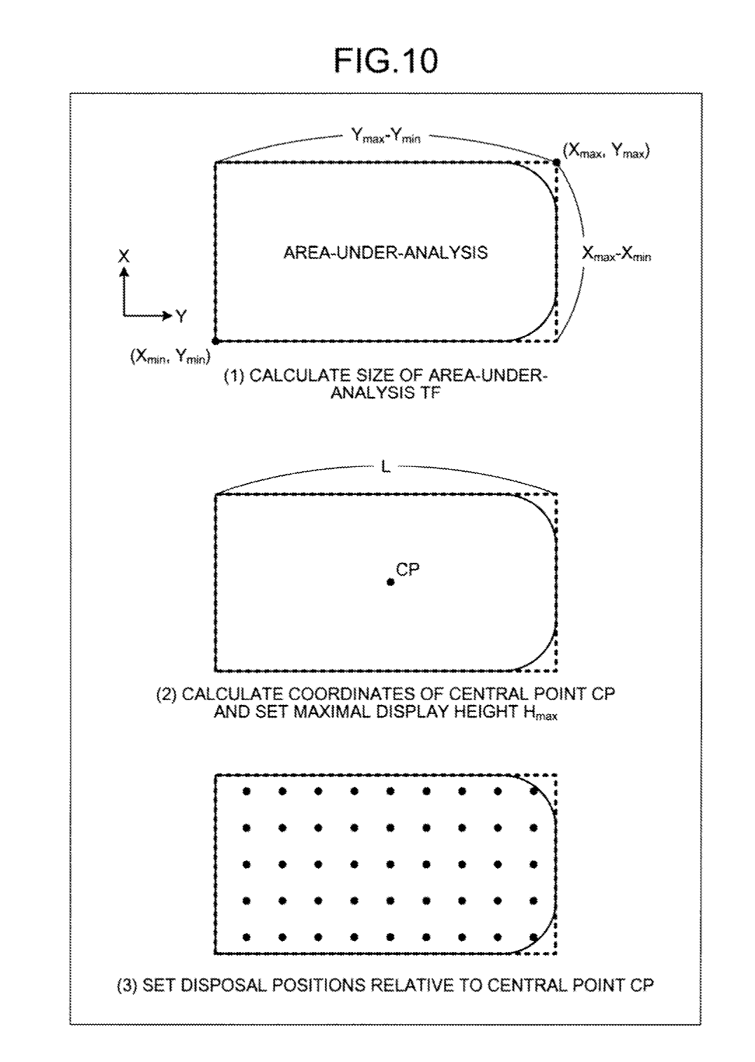

The extracting unit 703 depicted in FIG. 7 has a function of extracting from the object model file F input, nodes on the area-under-analysis TF selected. For example, the extracting unit 703 extracts from the object model node table 410, node information concerning the nodes on the area-under-analysis TF. The node information extracted is stored to, for example, an area-under-analysis node table 900 depicted in FIG. 9.

FIG. 9 is a diagram of an example of the content stored in the area-under-analysis node table. In FIG. 9, the area-under-analysis node table 900 has fields including “node ID” and “node coordinates”. Node information items 500-3 to 500-m are stored as records by setting information in each of the fields.

Herein, a node ID is an identifier of a node on the area-under-analysis TF. The node coordinates are the coordinates of a node on the area-under-analysis TF in the object model 300. In the embodiment, among nodes MN1 to MNn, the nodes MN3, MN5, . . . . , MNm are extracted whose coordinates on the Z-axis, which crosses the area-under-analysis TF at a right angle, are same as that of the reference point SP. The area-under-analysis node table 900 is stored in a storage area such as, for example, the RAM 203, the magnetic disk 205, and the optical disk 207.

The selecting unit 702 depicted in FIG. 7 has a function of selecting a pushing jig that applies a pushing force to the face of the object. For example, a user input via the keyboard 210 or the mouse 211 may also cause the selecting unit 702 to receive selection of an arbitrary pushing jig from among pushing jigs J1 to J3 in the jig library 600 depicted in FIG. 6.

For example, the user may select an arbitrary jig according to the state for which the user desires to analyze strength (e.g., the state of a button being pressed by a finger or a state where a phone strap is sandwiched by a cellular phone). The selecting unit 702 may select a pushing jig by referring to the disposal position information input. Hereinafter, an example where the pushing jig J1 is selected from among the pushing jigs J1 to J3 will be described unless indicated otherwise.

The setting unit 704 has a function of setting a disposal position to dispose thereat a pushing jig to apply a pushing force to the object. For example, the setting unit 704 sets a disposal position to dispose thereat the pushing jig J1 based on the jig dimension of the pushing jig J1 selected from the jig library 600. The “jig dimension” represents the size of the contact area (pushing face) of the pushing jig, contacting the surface of the object.

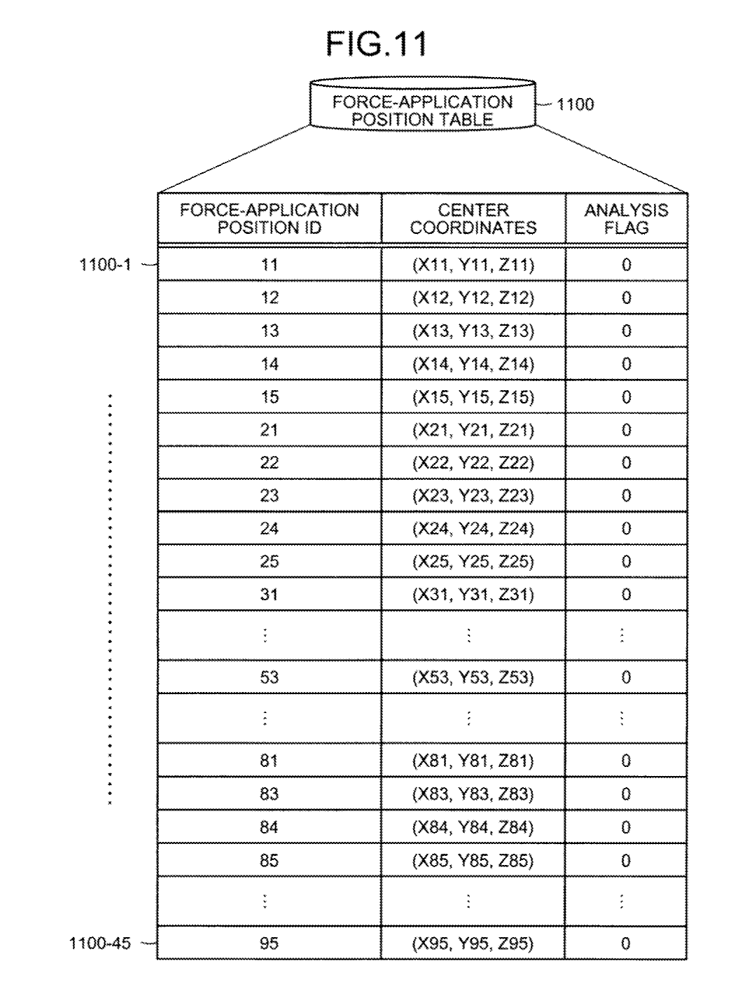

FIG. 10 is a diagram of an example of setting the disposal positions. (1) The setting unit 704 first calculates the size of the area-under-analysis TF. The area-under-analysis TF is a substantially rectangular plane that crosses the Z-axis at a right angle. Here, it is assumed that the area-under-analysis TF is rectangular and has a dimension along the X-axis direction as a longitudinal length and a dimension along the Y-axis direction as a lateral length.

In this example, the setting unit 704 determines the difference between the maximum and the minimum X-coordinates (Xₘₐₓ-Xₘᵢₙ) to be the longitudinal length of the area-under-analysis TF by referring to the area-under-analysis node table 900. For example, the setting unit 704 also determines the difference between the maximum and the minimum Y-coordinates (Yₘₐₓ-Yₘᵢₙ) to be the lateral length of the area-under-analysis TF by referring to the area-under-analysis node table 900.

(2) Thereafter, the setting unit 704 calculates the coordinates (X_{c}, Y_{c}) of a central point CP of the area-under-analysis TF and sets a length that is α-times (for example, ½ times) as long as a length L (in this case “Yₘₐₓ-Yₘᵢₙ”) in the longitudinal direction of the area-under-analysis TF to be the maximum display height Hₘₐₓ. An arbitrary value may be set as α. The maximum display height Hₘₐₓ will be described hereinafter.

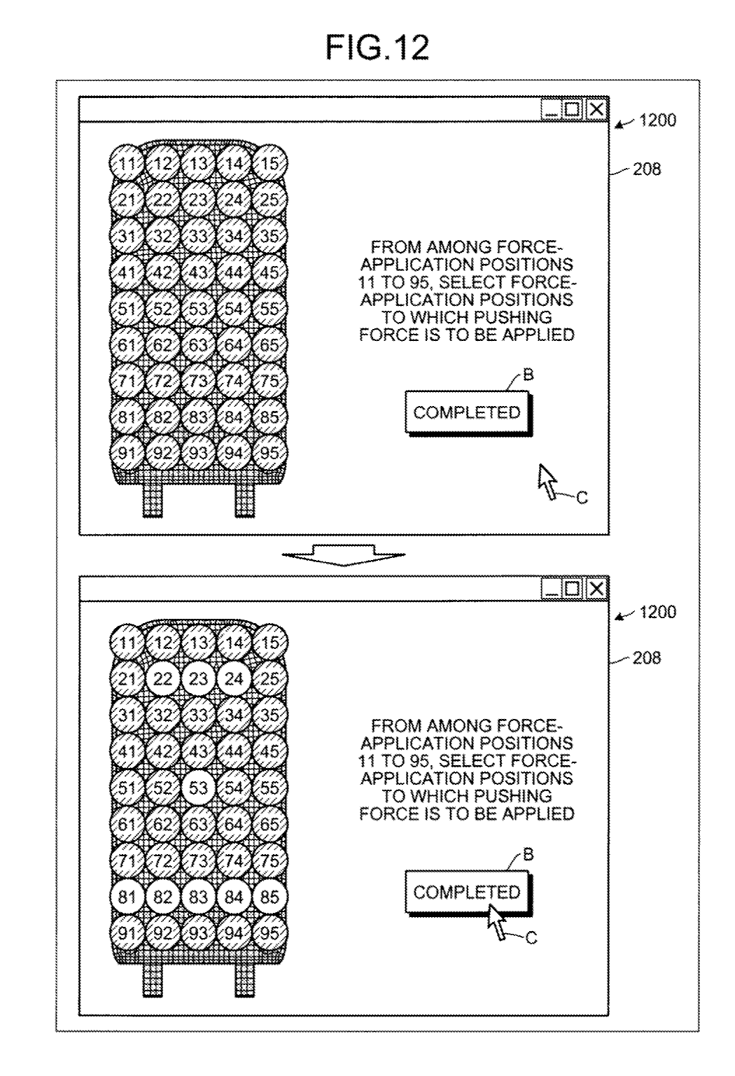

(3) Finally, the setting unit 704 sets the disposal positions (“” in FIG. 10) to dispose thereat the pushing jigs relative to the central point CP such that each interval between disposal positions that are adjacent in the X-axis or the Y-axis direction is substantially equivalent to the diameter of the pushing jig. The setting result set is stored in, for example, a force-application position table 1100 depicted in FIG. 11.

FIG. 11 is a diagram of an example of the content stored in the force-application position table. In FIG. 11, the force-application position table 1100 has fields including “force-application position ID”, “center coordinates”, and “analysis flag”. Force-application position information items 1100-1 to 1100-45 are stored as records by setting information in each of the fields.

A “force-application position ID” is an identifier of a force-application position at which a pushing force is applied to the object and is a matrix number of a “surface” described hereinafter. The “center coordinates” are the coordinates of the center of the “surface” described hereinafter and represents a disposal position at which a pushing jig is disposed (a disposal position set by the setting unit 704). The “analysis flag” is a flag that represents a force-application position at which a pushing force is applied during an analysis. “0” is set for the analysis flag in the initial state and “1” is set for it when the force-application position is selected as a force-application position to which a pushing force is to be applied.

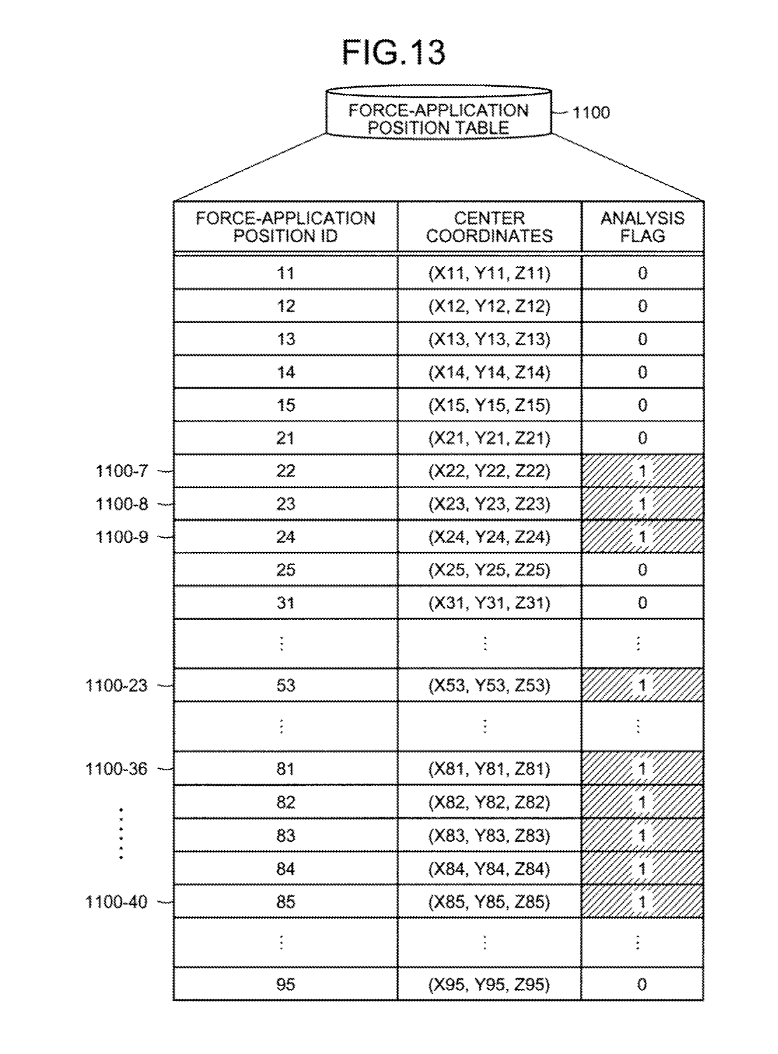

The selecting unit 702 in FIG. 7 has a function of selecting from among the disposal position group set on the surface of the object, multiple disposal positions to dispose thereat pushing jigs. For example, the user may manipulate a selection screen 1200 depicted in FIG. 12 and thereby, the selecting unit 702 may select the disposal positions from the disposal position group set. The selecting unit 702 may also select disposal positions from the disposal position group set, by referring to the disposal position information input.

FIG. 12 is a diagram of an example of a selection screen for disposal positions. As depicted in FIG. 12, the selection screen 1200 is an input screen that is displayed on the display 208 enabling selection of disposal positions at which pushing jigs are to be disposed, from among the disposal position group set on the surface of the object.

As described, the force-application positions on the object model 300 are represented by circular “surfaces” that each have a disposal position set on the surface of the object as a center and that each have the jig dimension of a pushing jig as a diameter. A number attached to each of the “surfaces” is an identifier of the “surface” (force-application position ID).

In the selection screen 1200, the user by manipulating the mouse 211 causes a cursor C to move and clicks an arbitrary “surface” whereby, a disposal position at which a pushing jig is disposed is selected. In this example, force-application positions 22, 23, 24, 53, 81, 82, 83, 84, and 85 are selected through an input operation by the user. When the cursor C is caused to move and click a completion button B, the input operation comes to an end and in the force-application position table 1100, “1” is set for the analysis flag of each of the force-application positions selected.

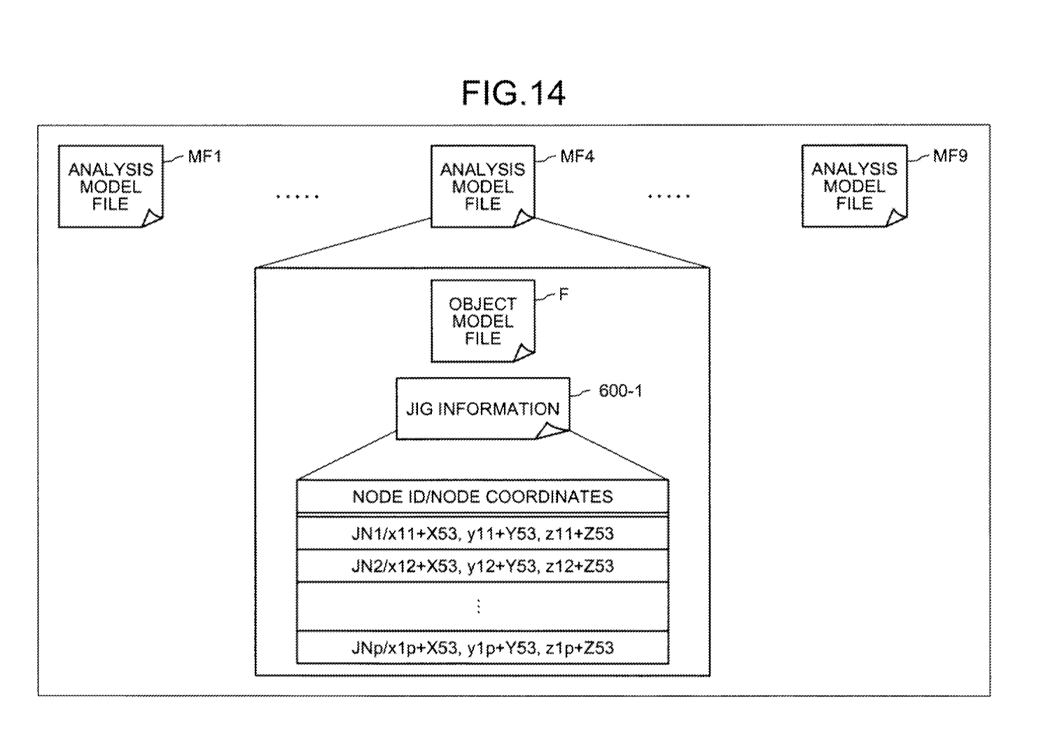

FIG. 13 is another diagram of the example of the content stored in the force-application position table. As depicted in FIG. 13, in the force-application position table 1100, “1” is set for the analysis flag of each of the force-application position information items 1100-7 to 1100-9, 1100-23, and 1100-36 to 1100-40 respectively corresponding to the force-application positions selected in the selection screen 1200.

Although the user selects disposal positions of the pushing jigs in the example herein, selection is not limited hereto. For example, the selecting unit 702 may select the disposal positions of the pushing jigs, based on a disposal position pattern (disposal position information) of the pushing jigs set in advance for each object model (area-under-analysis). The disposal position pattern is set based on, for example, the internal structure of the object (such as a driver, the position of sealing resin).

The creating unit 705 depicted in FIG. 7, has a function of creating an analytic model created by modeling a state where a pushing jig is disposed at a disposal position on the surface of the object, for each of the disposal positions selected, using the object model and the jig model. The “jig model” is a model of a pushing jig and corresponds to, for example, the jig information items 600-1 to 600-3 depicted in FIG. 6.

For example, the creating unit 705 aligns the center of the contact area of the pushing jig coming into contact with the surface of the object and the disposal position selected, thereby executing coordinate conversion of nodes included in the pushing jig and creating an analytic model file concerning the analytic model. An operative example of the analytic model file will be described.

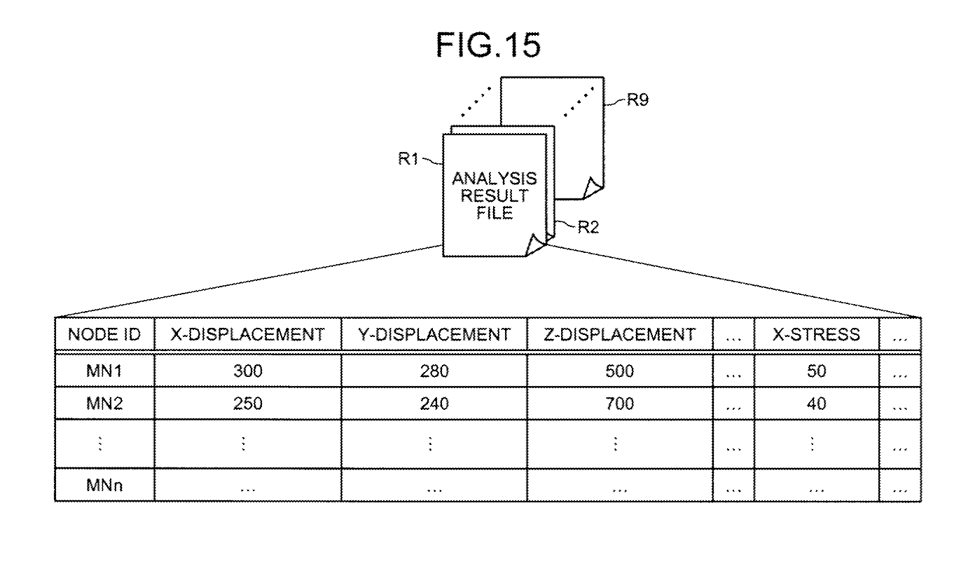

FIG. 14 is a diagram of an example of an analytic model file. In FIG. 14, analytic model files MF1 to MF9 are depicted for each disposal position at which the pushing jig J1 is disposed. Taking the analytic model file MF4 as an example, the analytic model file MF4 is an analytic model file created by modeling a state where the pushing jig J1 is disposed at the force-application position 53. The center of the contact area of the pushing jig J1 is aligned with the center coordinates (X53, Y53, Z53) of the force-application position 53, whereby the node coordinates of each of the nodes JN1 to JNp are converted.

The obtaining unit 706 has a function of obtaining the analysis result for each of the disposal positions by executing the strength analyses of the object using the analytic model created for each of the disposal positions. For example, the obtaining unit 706 supplies the analytic model files MF1 to MF9 to a simulator and thereby, obtains the analysis result for each of the force-application positions.

The analysis support apparatus 100 may execute the strength analysis of the object or the strength analysis may also be executed using an external simulator that is communicable through the network 214. The analysis result obtained is stored in a storage area such as the RAM 203, the magnetic disk 205, and the optical disk 207. An example of an analysis result for each of the disposal positions (force-application positions) will be described.

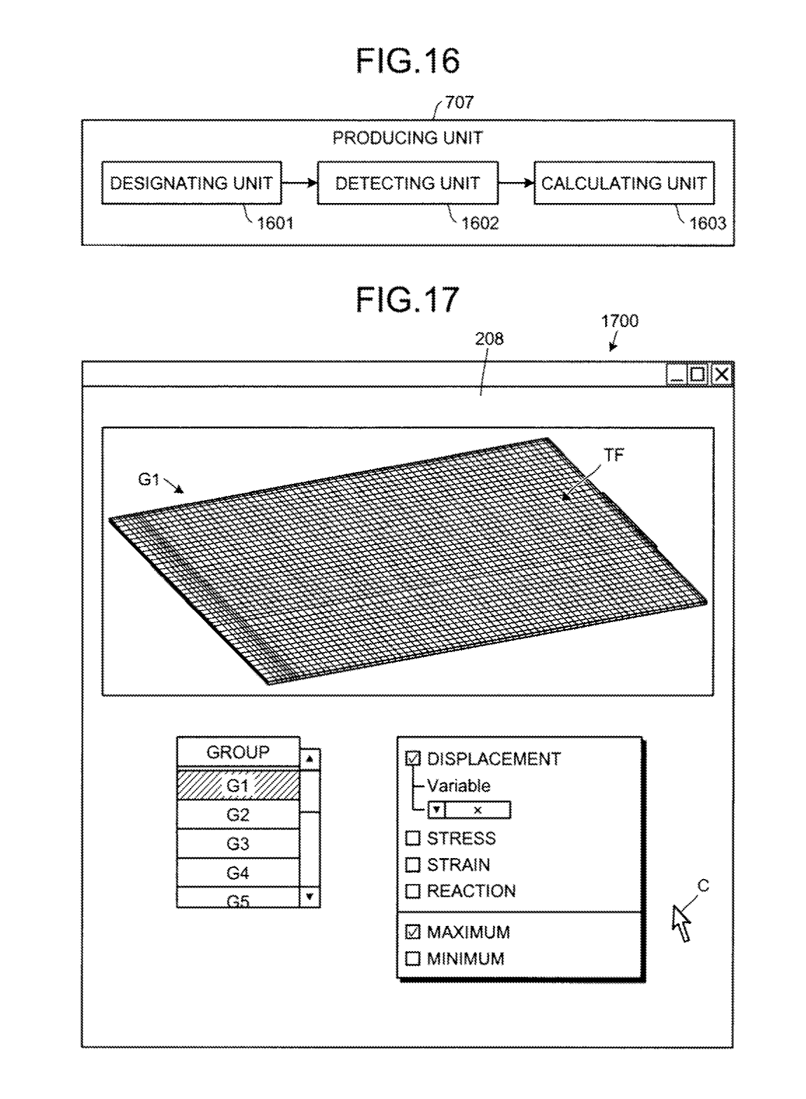

FIG. 15 is a diagram of an example of an analysis result file. In FIG. 15, analysis result files R1 to R9 for the force-application positions 11 to 15, 21 to 25, . . . , and 91 to 94 are depicted. Taking, as an example, the analysis result file R1 for the force-application position 11, analytic values for the nodes MN1 to MNn included in the object model 300 are stored therein.

For example, the analysis result file R1 stores therein analytic values concerning multiple evaluation items. The “evaluation items” include, for example, displacement (DISPLACEMENT), stress (STRESS), strain (STRAIN), reaction force (REACTION), etc., for the direction of each of the axes on the surface of the object.

The producing unit 707 in FIG. 7 has a function of producing a chart that displays the analysis results at the disposal positions on the surface of the object based on the analysis results obtained for the disposal positions. For example, the producing unit 707 correlates the disposal positions of the pushing jigs and the analysis results obtained when the pushing jigs are disposed at the disposal positions and thereby, creates a chart that displays the analysis results at the disposal positions on the surface of the object. The specific content of the processing by the producing unit 707 will be described hereinafter.

The output unit 708 has a function of outputting the chart produced. For example, the output unit 708 may output charts 2100 to 2300 as those depicted in FIGS. 21 to 23. The form of output may be, for example, display on the display 208, print out by output to the printer 213, and transmission to an external apparatus by the I/F 209. The charts produced may be stored in a storage area such as the RAM 203, the magnetic disk 205, and the optical disk 207.

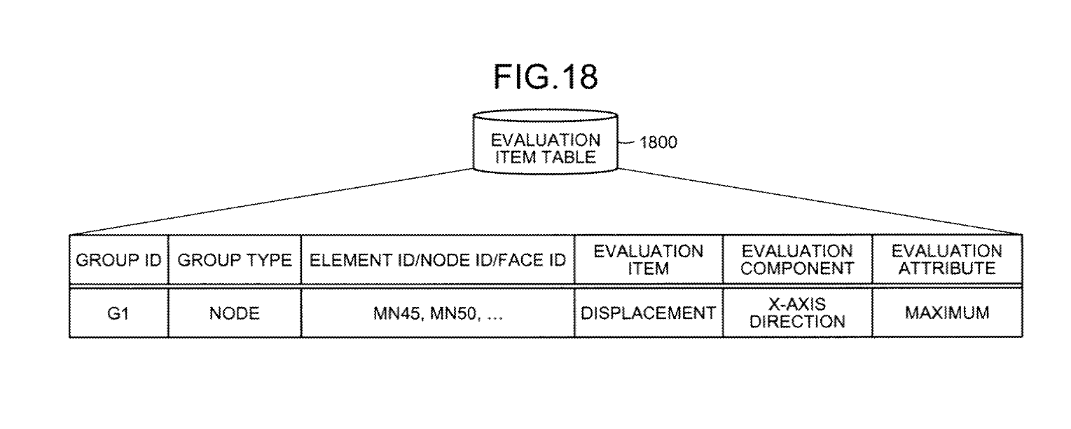

FIG. 16 is a block diagram of an example of the functional configuration of the producing unit. As depicted in FIG. 16, the producing unit 707 includes a designating unit 1601, a detecting unit 1602, and a calculating unit 1603.

The designating unit 1601 has a function of receiving designation of evaluation items to be displayed, from among evaluation items included in the analysis results. For example, user manipulation of the keyboard 210 or the mouse 211 may cause the designating unit 1601 to receive the designation of the evaluation items to be displayed.

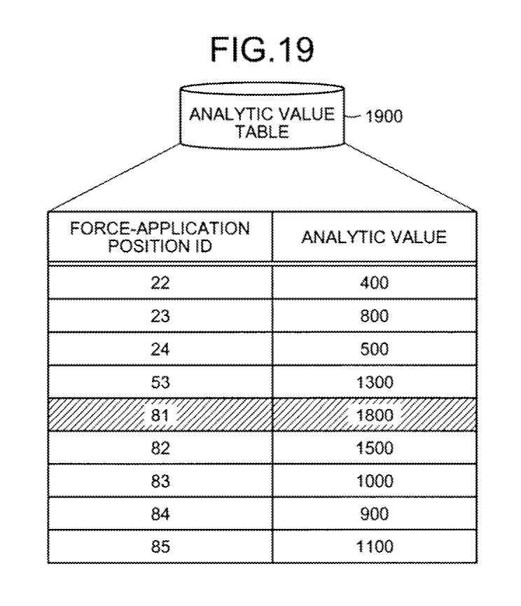

FIG. 17 is a diagram of an example of a designation screen for the evaluation items. In FIG. 17, a designation screen 1700 is an input screen that is displayed on the display 208 to designate the evaluation items to be displayed, from among the evaluation items.

In the designation screen 1700, the user by manipulating the mouse 211, causes the cursor C to move to designate a group to be evaluated. A “group” is a set of elements, nodes, or contact areas to be evaluated and is set in advance. In this case, a group G1 that represents a set of all the nodes on the area-under-analysis TF is designated to be evaluated.

In the designation screen 1700, user manipulation of the mouse 211 causes the display and designation of evaluation items. In this example, “DISPLACEMENT” representing displacement on the surface of the object is designated as an evaluation item.

Thereafter, in the designation screen 1700, user manipulation of the mouse 211 causes the display and designation of a component “Variable” of the evaluation items. In this example, a component in the X-axis direction is designated among components in the X-axis, the Y-axis, and the Z-axis directions on the surface of the object.

Finally, in the designation screen 1700, user manipulation of the mouse 211 causes the display and designation of attributes (such as the maximum, the minimum, and the average) of the evaluation items. In this example, “MAXIMUM” that represents the maximum of an evaluation item is designated.

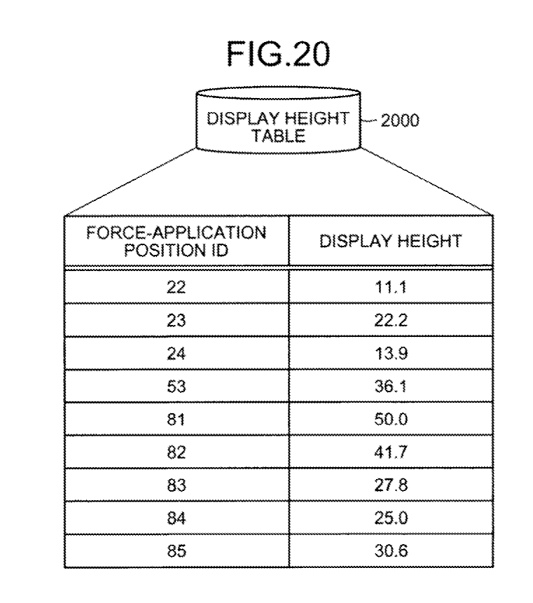

According to the above series of operation inputs, the maximum displacement among displacement along the X-axis direction at each of the nodes on the area-under-analysis TF is displayed as an analytic value. The designation result is stored in, for example, an evaluation item table 1800 depicted in FIG. 18.

FIG. 18 is a diagram of an example of the content stored in the evaluation item table. In FIG. 18, the evaluation item table 1800 has fields including “group ID”, “group type”, “element ID/node ID/contact area ID”, “evaluation item”, “evaluation component”, and “evaluation attribute”. Information concerning the evaluation items is stored as records by setting information in each of the fields.

A “group ID” is an identifier of a group. A “group type” is the type of a group to be evaluated and is any one of element, node, and contact area. The “element ID/node ID/contact area Id” is an identifier of an element, a node, or a contact area included in a group. An “evaluation item” is an evaluation item to be displayed. An “evaluation component” is a component of an evaluation item. An “evaluation attribute” is an attribute of an evaluation item.

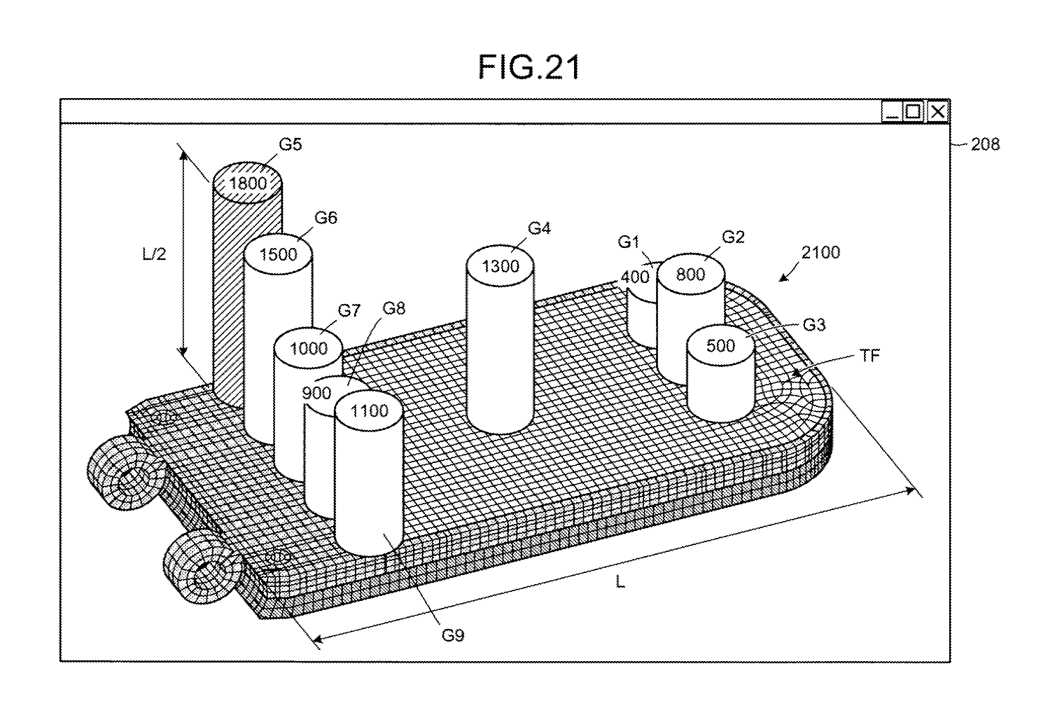

The detecting unit 1602 in FIG. 16 has a function of detecting analytic values of the evaluation items designated, from the analysis results obtained at the disposal positions. For example, the detecting unit 1602 refers to the evaluation item table 1800 and thereby, detects the maximum displacement along the X-axis direction among the nodes in the group G1, from the analysis result files R1 to R9. The detection result is stored in an analytic value table 1900 depicted in FIG. 19.

FIG. 19 is a diagram of an example of the content stored in the analytic value table. In FIG. 19, the analytic value table 1900 has fields including “force-application position ID” and “analytic value”. Analytic values of each of the force-application positions are stored as records by setting information in each of the fields. A “force-application position ID” is an identifier of a force-application position. An “analytic value” is an analytic value corresponding to an evaluation item designated. In this example, the maximum displacement along the X-axis direction is stored.

The calculating unit 1603 in FIG. 16 has a function of calculating display heights to display analysis results for the disposal positions of the pushing jigs. For example, the calculating unit 1603 first refers to the analytic value table 1900 and thereby, identifies a maximum analytic value of the analytic values for the force-application positions. In this example, an analytic value “1800” at the force-application position 81 is identified.

Thereafter, the calculating unit 1603 calculates the display heights of the analytic value of each of the force-application positions using, for example, Equation (1) below, where “H” is the display height of a force-application position ID “ij”, “Hₘₐₓ” is the maximum display height, “rₘₐₓ” is the maximum analytic value, and “rᵢⱼ” is an analytic value of the force-application position ID “ij”.

Hᵢⱼ=Hₘₐₓ/rₘₐₓ×rᵢⱼ (1)

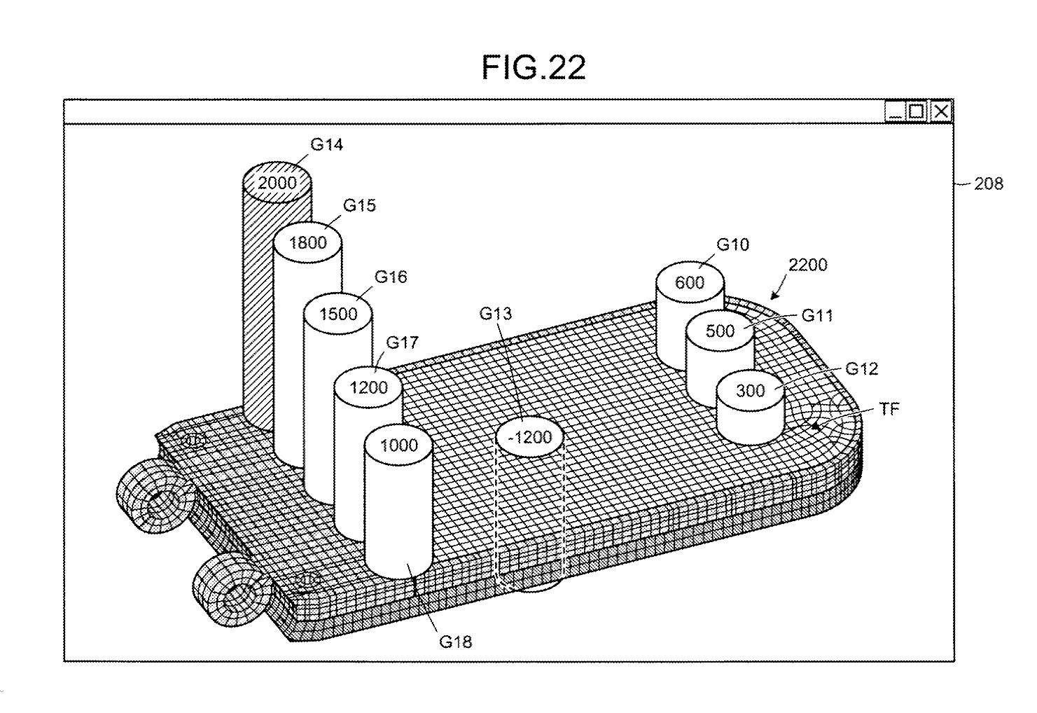

Assuming that the maximum display height Hₘₐₓ is “Hₘₐₓ=50” and taking the force-application position 22 as an example, a display height H₁₁ is “H₁₁=50/1800×400≈11.1”. The display height calculated is stored in a display height table 2000 depicted in FIG. 20.

FIG. 20 is a diagram of an example of the content stored in the display height table. In FIG. 20, a display height table 2000 has fields including “force-application position ID” and “display height”. The display heights for the force-application positions are stored as records by setting information in each of the fields. A “force-application position ID” is an identifier of a force-application position. A “display height” is the display height of an analytic value at each of the force-application positions.

The producing unit 707 in FIG. 16 has a function of producing a chart to display therein bar graphs of the heights that correspond to the analysis results in predetermined areas each centered about a disposal position corresponding to the analysis result. In this example, the “predetermined area” is, for example, a circular “surface” having a diameter of the jig dimension of the pushing jig. The jig dimension of a pushing jig is identified from the jig library 600.

For example, the producing unit 707 first refers to the display height table 2000 and thereby, identifies the “surfaces” (the force-application positions 22 to 24, 53, and 81 to 85) on the area-under-analysis TF for which bar graphs are displayed. Each of the “surfaces” (force-application positions) is identified from the center coordinates in the force-application position table 1100.

Thereafter, the producing unit 707 refers to the display height table 2000, pushes out each of the “surfaces” by the display height for each of the force-application positions and, thereby, produces a bar graph at each of the force-application positions. The producing unit 707, for each of the force-application positions, inserts a corresponding analytic value at an upper end of the bar graph at each force-application position.

FIG. 21 is a diagram of an exemplary screen that displays the produced chart. In FIG. 21, the display 208 displays a chart 2100 of bar graphs G1 to G9 respectively having a height corresponding to the analytic values of the force-application positions 22 to 24, 53, and 81 to 85 (see FIG. 12) on the area-under-analysis TF of the analytic model.

On an upper end of each of the bar graphs G1 to G9, the analytic value corresponding thereto is displayed. The bar graph G5, which represents the maximum analytic value, is expressed using a different color from that of the other bar graphs G1 to G4, and G6 to G9. The display height of the bar graph G5 (the maximum display height Hₘₐₓ) is b 1/2 times (α=½) the longitudinal length L of the area-under-analysis TF. This is set such that the maximum display height Hₘₐₓ of the bar graph is a proper size relative to the size of the entire object model 300.

In the chart 2100, the analytic value at each of the force-application positions is graphically expressed and therefore, the user is supported in intuitively understanding and relatively evaluating the analytic values of the force-application positions. Thereby, the identification of weak points is facilitated.

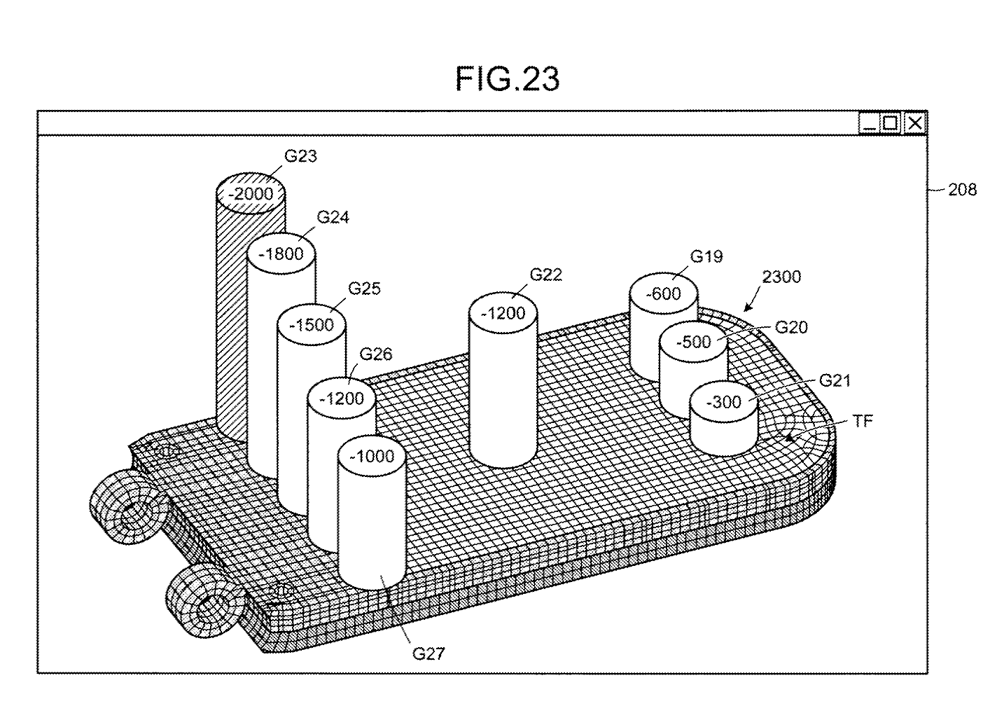

If positive values and negative values are mixed among the analytic values of different force-application positions, bar graphs may be displayed to appear to be pushed downward at the force-application positions having analytic values that are negative. FIG. 22 is a diagram of another exemplary screen.

In FIG. 22, the display 208 displays a chart 2200 of bar graphs G10 to G18 respectively having a height corresponding to the analytic values of the force-application positions 22 to 24, 53, and 81 to 85 (see FIG. 12) on the area-under-analysis TF of the analytic model. In FIG. 22, the bar graph G13 is displayed to appear being pushed downward because the value of the analytic value is negative at the force-application position 53.

If the analytic values of different force-application positions are each negative values, the bar graphs at each of the force-application positions may be displayed to appear to be pushed upward. The display height of each bar graph in this case may be obtained by multiplying the display height obtained using Equation (1) by “−1”.

FIG. 23 is a diagram of another exemplary screen. In FIG. 23, the display 208 displays a chart 2300 of bar graphs G19 to G27 respectively having a height corresponding to the analytic values of the force-application positions 22 to 24, 53, and 81 to 85 (see FIG. 12) on the area-under-analysis TF of the analytic model.

In FIG. 23, the bar graphs G19 to G27 are each pushed upward because the values of the analytic values are negative at each of the force-application positions. The bar graph G23 having an analytic value for which the absolute value is the maximum among those of the bar graphs G19 to G27, is expressed using a color different from that of other bar graphs G19 to G22 and G24 to G27.

Further, a dividing unit not depicted in the producing unit 707 may divide the surface of the object into mesh areas. For example, the dividing unit divides the surface of the object into mesh areas each having a mesh width of the diameter of the pushing jig J1 and each centered about the disposal position of the pushing jig set on the surface. In this example, the producing unit 707 may produce a chart that displays bar graphs of the heights corresponding to the analysis results in mesh areas each centered about the disposal position and corresponding to the analysis results of the divided mesh areas.

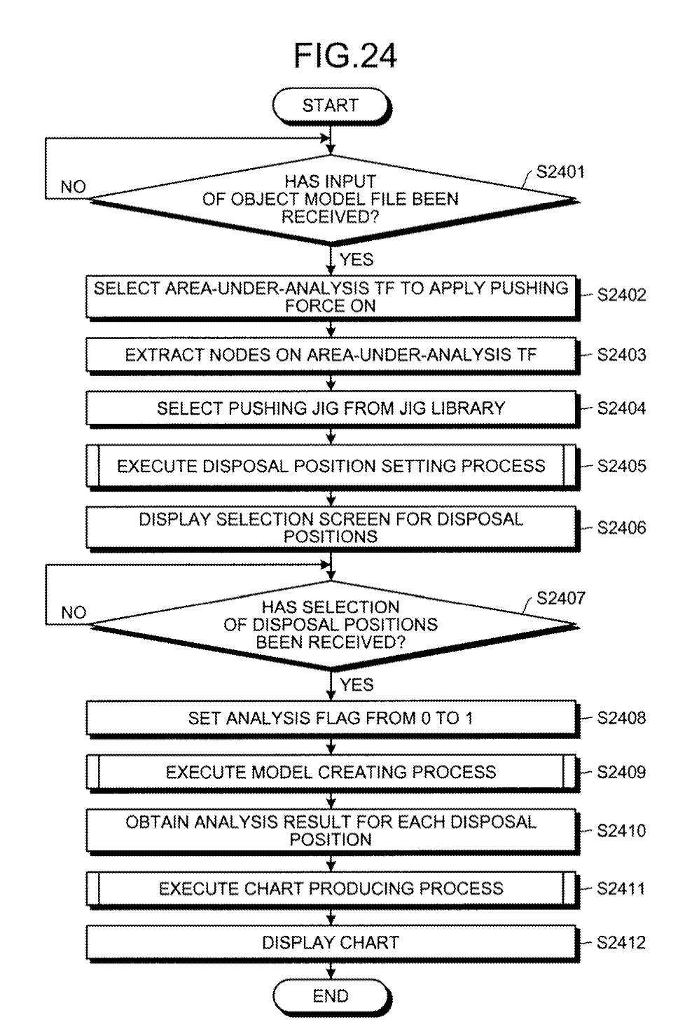

FIG. 24 is a flowchart of an example of an analysis support process procedure of the analysis support apparatus. As depicted in FIG. 24, it is first determined whether the input unit 701 has received input of the object model file F (step S2401).

The input of the object model file F is waited for (step S2401: NO). When it is determined that the input has been received (step S2401: YES), the selecting unit 702 selects an area-under-analysis TF of the surface of the object model and to which a pushing force is to be applied, (step S2402).

The extracting unit 703 extracts nodes from the area-under-analysis TF selected from the object model file F1 received (step S2403). Node information concerning the extracted nodes is stored to the object node table 900.

Thereafter, the selecting unit 702 selects, from the jig library 600, pushing jigs to which the pushing force is to be applied to apply a force to the area-under-analysis TF (step S2404). The setting unit 704 executes a disposal position setting process of setting the disposal positions to dispose thereat the pushing jigs for applying the pushing force to the object (step S2405). The setting result is stored to the force-application position table 1100.

The output unit 708 displays on the display 208, the selection screen 1200 of the disposal positions to dispose thereat the pushing jigs, based on the force-application position table 1100 (step S2406). Thereafter, the selecting unit 702 determines whether a selection of disposal positions for disposing thereat the pushing jigs has been received, the selection being from among the disposal position group set on the surface of the object (step S2407).

Reception of a selection of the disposal positions is waited (step S2407: NO). When it is determined that selection have been received (step S2407: YES), the selecting unit 702 sets “1” in the analysis flag of the corresponding record in the force-application position table 1100 (step S2408).

The creating unit 705 executes a model creating process of creating the analytic model created by modeling a state where a pushing jig is disposed at each of the selected disposal positions on the surface of the object (step S2409). The obtaining unit 706 executes the strength analysis of the object using each analytic model created respectively for the disposal positions and thereby, obtains the analysis result for each of the disposal positions (step S2410).

Thereafter, the producing unit 707 executes a chart producing process of producing a chart that displays the analysis results at the disposal positions on the surface of the object, based on the analysis results obtained for the disposal positions (step S2411). Finally, the output unit 708 displays the chart created on the display 208 (step S2412) and a series of processes according to the flowchart comes to an end.

Thus, when strength analysis is executed multiple times, changing the force-application position on the surface of the object, the work load and the working time to produce analytic models for force-application positions may be reduced. The user may be supported in intuitively understanding and evaluating the strength of the object, by collectively and graphically displaying the analysis results at the respective force-application positions on the surface of the object.

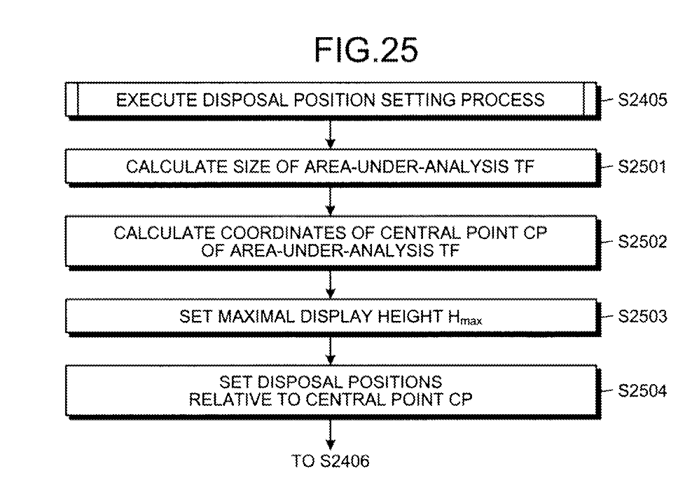

FIG. 25 is a flowchart of an example of a process procedure of the disposal position setting process. In the flowchart of FIG. 25, the setting unit 704 first refers to the area-under-analysis node table 900 and thereby, calculates the size of the area-under-analysis TF (step S2501).

Thereafter, the setting unit 704 calculates the coordinates of the central point CP of the area-under-analysis TF (step S2502). The setting unit 704 sets a length that is ½ of the longitudinal length of the area-under-analysis TF to be the maximum display height Hₘₐₓ (step S2503).

Finally, the setting unit 704 sets disposal positions relative to the central point CP such that each interval between disposal positions that are adjacent along the X-axis or the Y-axis direction is the diameter of the pushing jig (step S2504) and the procedure is moved to step S2406 depicted in FIG. 24. The setting result is stored to the force-application position table 1100.

Thereby, the disposal positions to dispose thereat arbitrary jigs on the surface of the object may automatically be set based on the size of the pushing face (contact area) of the arbitrary pushing jig selected from the jig library 600.

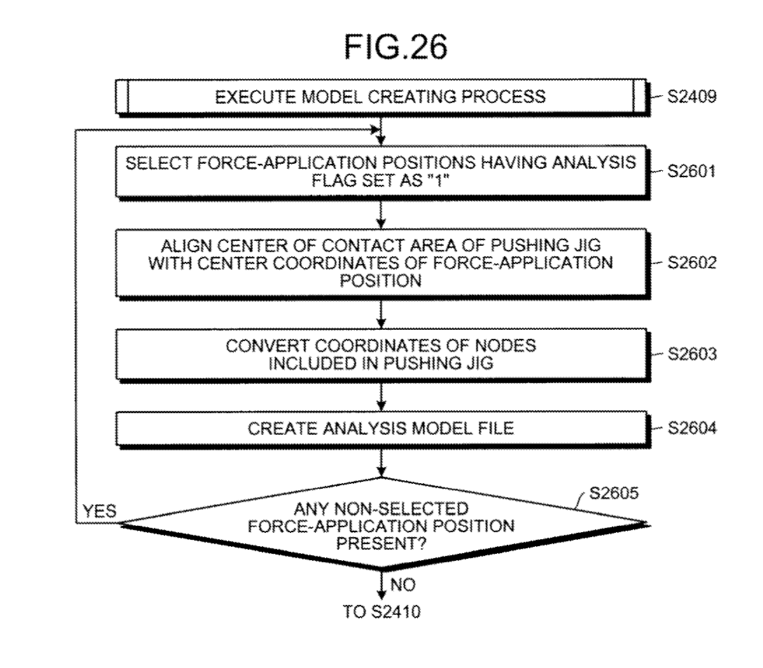

FIG. 26 is a flowchart of an example of a process procedure of the model creating process.

In the flowchart of FIG. 26, the creating unit 705 refers to the force-application position table 1100 and thereby, selects the force-application positions having analysis flags of “1” (step S2601). The creating unit 705 aligns the center of a contact area of a pushing jig and the center coordinates of the force-application position selected (step S2602).

Thereafter, the creating unit 705 executes coordinate conversion of the nodes included in the pushing jig (step S2603) and thereby, creates the analytic model file concerning the analytic model (step S2604). The creating unit 705 determines whether any force-application positions that have not been selected is present, among the force-application positions whose analysis flags each have “1” set therefor (step S2605).

If it is determined that force-application positions that have not been selected are present (step S2605: YES), the procedure returns to step S2601. On the other hand, if it is determined that each of the force-application positions has been selected (step S2605: NO), the procedure proceeds to step S2410 depicted in FIG. 24.

Thereby, an analytic model file created by modeling a state where the pushing jig is disposed on the surface of the object is automatically be created for each of the disposal positions selected from the disposal position group that is automatically set on the surface of the object. An analytic model file for each of the disposal positions is automatically created from one object model file F and therefore, if any mistake is found after the analysis, the object model file F, which is the source for creation, alone has to be corrected and therefore, the work load for the correction work is reduced.

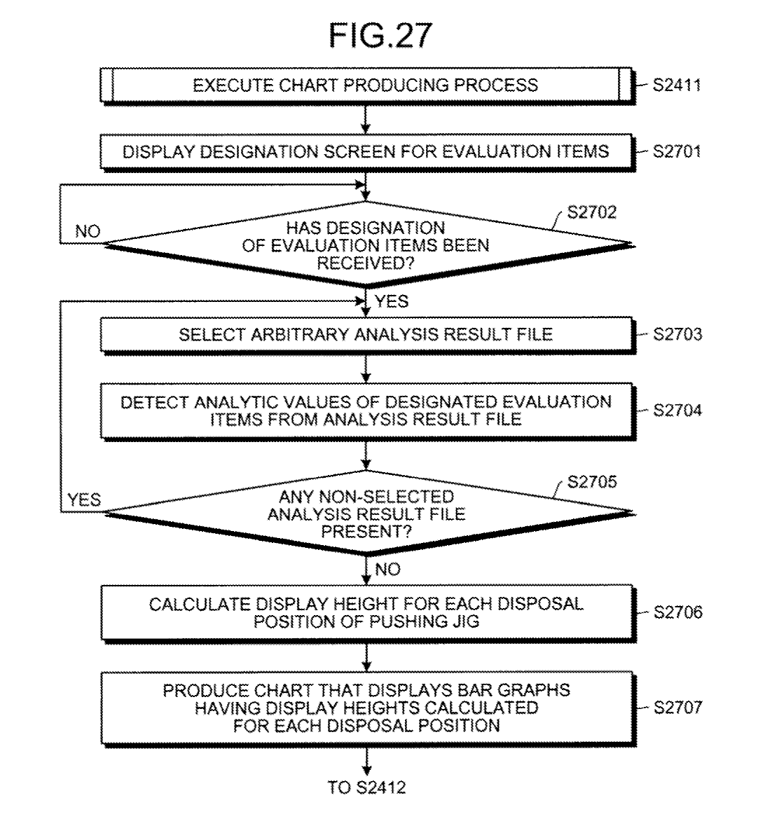

FIG. 27 is a flowchart of an example of a process procedure of the chart creating process. As depicted in the flowchart of FIG. 27, the output unit 708 displays on the display 208, the designation screen 1700 of the evaluation items (step S2701). The designating unit 1601 determines whether designation has been received for the evaluation items to be displayed from among the evaluation items included in the analysis results (step S2702).

Reception of the designation of the evaluation items is waited for (step S2702: NO). When it is determined that the designation has been received (step S2702: YES), the detecting unit 1602 selects an arbitrary analysis result file from the analysis result files for the disposal positions (step S2703). The designation result designated at step S2702 is stored to the evaluation item table 1800.

Thereafter, the detecting unit 1602 detects the analytic values of the evaluation items designated from the selected analysis result file (step S2704). For example, the detecting unit 1602 refers to the force-application position table 1100 and thereby, detects the analytic values of the force-application positions having analysis flags of “1” set therefore. The detection result is stored to the analytic value table 1900. The detecting unit 1602 determines whether any analysis result file that has not been selected is present (step S2705).

If it is determined that an analysis result file that has not been selected is present (step S2705: YES), the procedure returns to step S2703. On the other hand, if it is determined that each of the analysis result files has been selected (step S2705: NO), the calculating unit 1603 calculates a display height for each of the disposal positions of the pushing jigs using Equation (1) above (step S2706). The display heights calculated are stored to the display height table 2000.

The producing unit 707 produces a chart that at each of the disposal positions on the object, displays bar graphs respectively having the display heights calculated respectively for the disposal positions (step S2707) and the procedure proceeds to step S2412 depicted in FIG. 24.

Thereby, the user is supported in intuitively understanding and relatively evaluating the analysis result of each of the force-application positions and therefore, the identification of weak points is facilitated.

As described, according to the embodiment, an analytic model that is created by modeling the state where a pushing jig is disposed on the surface of an object is automatically created for each of the disposal positions selected from a disposal position group that is automatically set on the surface of the object. Strength analysis of the object is executed, whereby analysis results for the disposal positions are obtained, the disposal positions and the analysis results of the disposal positions are correlated, creating a chart that displays the corresponding analysis results on the surface of the object.

Thus, when strength analysis is executed multiple times, changing the force-application position on the surface of the object, the work load and time involved in producing an analytic model for each of the force-application positions is reduced. The user is supported in intuitively understanding and executing the strength evaluation of the object, by collectively and graphically displaying on the surface of the object, the analysis results at corresponding force-application positions.

According to the embodiment, the disposal positions to dispose thereat arbitrary jigs on the surface of the object may automatically be set based on the size of the pushing face (contact area) of the arbitrary pushing jig selected from the jig library 600.

According to the embodiment, a bar graph having the height corresponding to the analysis result may be displayed in a predetermined area centered about the disposal position that corresponds to the analysis result. Thereby, the user is supported in intuitively understanding and relatively evaluating the analysis results of the force-application positions. Thereby, the identification of weak points is facilitated.

According to the embodiment, a chart is produced that displays, at the corresponding disposal position, the maximum analytic value among the analytic values in each group (the group set in the evaluation item table 1800) included in the analysis results. Thereby, the user is supported in intuitively understanding and determining at which force-application position on the object, application of a pushing force significantly affects the object, for a predetermined evaluation item.

According to the embodiment, a chart is produced that displays, at the corresponding disposal positions, the average value of the analytic values of each group (the group set in the evaluation item table 1800) included in the analysis results. Thereby, the user is supported in intuitively understanding and determining at which force-application position on the object, application of a pushing force on average significantly affects the object, for a predetermined evaluation item.

According to the embodiment, the maximum analytic value of the analytic values displayed on the object may be displayed using a first color and other analytic values may be displayed using a second color. Thereby, the force-application positions may be distinguished from each other as to at which force-application position on the object application of a pushing force most significantly affects the object, for a predetermined evaluation item.

The analysis support method described in the present embodiment may be implemented by executing a prepared program on a computer such as a personal computer and a workstation. The program is stored on a computer-readable recording medium such as a hard disk, a flexible disk, a CD-ROM, an MO, and a DVD, read out from the recording medium, and executed by the computer. The program may be a transmission medium that can be distributed through a network such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory, computer-readable recording medium storing therein an analysis support program that causes a computer to execute a process comprising:
receiving input of disposal position information that indicates respective disposal positions for jigs in information that indicates disposal positions set on a surface of an object model modeling an object;
creating, using the object model and a jig model modeling a jig, an analytic model by modeling a state where the jigs are disposed respectively at the disposal positions that are on the surface of the object and indicated by the disposal position information received at the receiving;
obtaining an analysis result for each of the disposal positions by executing strength analysis of the object using the analytic model that is for each of the disposal positions and created at the creating;
producing, by correlating the disposal positions and the analysis results based on the analysis result for each of the disposal positions obtained at the obtaining, a chart that displays at each of the disposal positions on the surface of the object, a correlated analysis result; and
outputting the chart produced at the producing.

2. The recording medium according to claim 1 and storing therein the analysis support program causing the computer to execute the process further comprising setting a disposal position to dispose thereat an arbitrary jig that is selected from among the jigs, based on a size of a contact area of the arbitrary jig, the contact area contacting the surface of the object, wherein
the receiving includes receiving disposal position information that corresponds to a disposal position group set at the setting.

3. The recording medium according to claim 1, wherein
the producing includes producing a chart that displays, at a disposal position, a bar graph having a height that corresponds to the analysis result for the disposal position.

4. The recording medium according to claim 3, wherein
the analysis result for each of the disposal positions obtained at the obtaining includes, for each of the disposal positions set on the surface of the object model, an analytic value concerning a predetermined evaluation item obtained when a pushing force is applied at the disposal position, and
the producing includes producing a chart that displays a maximum analytic value of analytic values included in the analysis result, at a disposal position that corresponds to the analysis result.

5. The recording medium according to claim 3, wherein
the analysis result for each of the disposal positions obtained at the obtaining includes, for each of the disposal positions set on the surface of the object model, an analytic value concerning a predetermined evaluation item obtained when a pushing force is applied at the disposal position, and
the producing includes producing a chart that displays an average analytic value of analytic values included in the analysis result, at a disposal position that corresponds to the analysis result.

6. The recording medium according to claim 4, wherein
the producing further includes producing the graph that displays the maximum analytic value using a first color and displays other analytic values that are different from the maximum analytic value using a second color.

7. The recording medium according to claim 5, wherein
the producing includes producing the graph that displays a maximum analytic value of analytic values displayed using a first color and other analytic values that are different from the maximum analytic value using a second color.

8. An analysis support apparatus comprising:
an input unit configured to receive input of disposal position information that indicates respective disposal positions for jigs in information that indicates disposal positions set on a surface of an object model modeling an object;
a creating unit configured to create, using the object model and a jig model modeling a jig, an analytic model by modeling a state where the jigs are disposed respectively at the disposal positions that are on the surface of the object and indicated by the disposal position information received by the input unit;
an obtaining unit configured to obtain an analysis result for each of the disposal positions by executing strength analysis of the object using the analytic model that is for each of the disposal positions and created by the creating unit;
a producing unit configured to correlate, based on the analysis result for each of the disposal positions obtained by the obtaining unit, the disposal positions and the analysis results for the disposal positions, and produce a chart that displays at each of the disposal positions on the surface of the object, a correlated analysis result; and
an output unit configured to output the chart produced by the producing unit.

9. An analysis support method comprising:
receiving input of disposal position information that indicates respective disposal positions for jigs in information that indicates disposal positions set on a surface of an object model modeling an object;
creating, using the object model and a jig model modeling a jig, an analytic model by modeling a state where the jigs are disposed respectively at the disposal positions that are on the surface of the object and indicated by the disposal position information received at the receiving;
obtaining an analysis result for each of the disposal positions by executing strength analysis of the object using the analytic model that is for each of the disposal positions and created at the creating;
producing, by correlating the disposal positions and the analysis results based on the analysis result for each of the disposal positions obtained at the obtaining, a chart that displays at each of the disposal positions on the surface of the object, a correlated analysis result; and
outputting the chart produced at the producing.
